(19) United States
(12) Patent Application Publication
(10) Pub. No.: US 2016/0267293 A1
(43) Pub. Date: Sep. 15, 2016

(54) Validating a Query Execution

(71) Applicant: HEWLETT-PACKARD ENTERPRISE DEVELOPMENT LP, Houston, TX (US)

(72) Inventors: Suresh Subbiah, Plano, TX (US); Roberta S. Marton, Freemont, CA (US); Hansjorg Zeller, Los Altos, CA (US); Barry Lynn Fritchman, Lake Forest, CA (US); Gayle M. Schultz, Palo Alto, CA (US); James A. Capps, Austin, TX (US); Michael J. Hanlon, Austin, TX (US)

(73) Assignee: Hewlett Packard Enterprise Development LP, Houston, TX (US)

(21) Appl. No.: 15/032,113

(22) PCT Filed: Oct. 29, 2013
(86) PCT No.: PCT/US2013/067194

§ 371 Date: Apr. 26, 2016

(51) Int. Cl. G06F 21/62; G06F 17/30; G06F 9/45; G06F 21/80

(52) U.S. Cl. CPC G06F 21/6227; G06F 21/805; G06F 17/30339; G06F 21/62; G06F 8/41

(57) ABSTRACT

Validating a query execution includes determining whether a condition of a query has changed and recompiling the query if the condition has changed.

### BACKGROUND

When a relational database management system receives a query from a user, the system generates a query plan to execute the request. In some instances, generating the query plan is expensive, so the query and its associated plan are stored in a local cache. If the same query is requested at a future date, the saved query and plan can save time by reusing the earlier generated query plan.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is a diagram of an example of a validation system according to the principles described herein.

FIG. 2 is a diagram of an example of a query identification table according to the principles described herein.

FIG. 3 is a diagram of an example of a central hash table according to the principles described herein.

FIG. 4 is a diagram of an example of a method for validating a query execution according to the principles described herein.

FIG. 5 is a diagram of an example of a validation system according to the principles described herein.

FIG. 6 is a diagram of an example of a validation system according to the principles described herein.

### DETAILED DESCRIPTION

Reusing queries that are saved to local caches can save time and resources because duplicate query plan generation is avoided. However, the conditions of the query may change over time. For example, the first time a user requests a query, the user has permission to perform the request and the compiled query plan may be cached. Subsequently, the user may request the same query. However, during the time lapse between the first and subsequent time, the user's privileges may have changed to prevent the user from running the query. Other conditions may have changed during the time lapse, like the query index may have changed, rows may have been added to database tables, the relationship between database objects may have changed, other conditions may have changed, or combinations thereof. Such relationships may include triggers, referential integrity constraints, views, other types of relationships, or combinations thereof. Thus, the reuse of the saved query plan in its original form may be incorrect or not be ideal.

The principles described herein include a method for validating a query execution that is suitable for both a single computer as well as a cluster of servers. Such a method may include determining whether a condition of a query has changed and recompiling the query if the condition has changed. The details of such a method will be described in more detail below.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

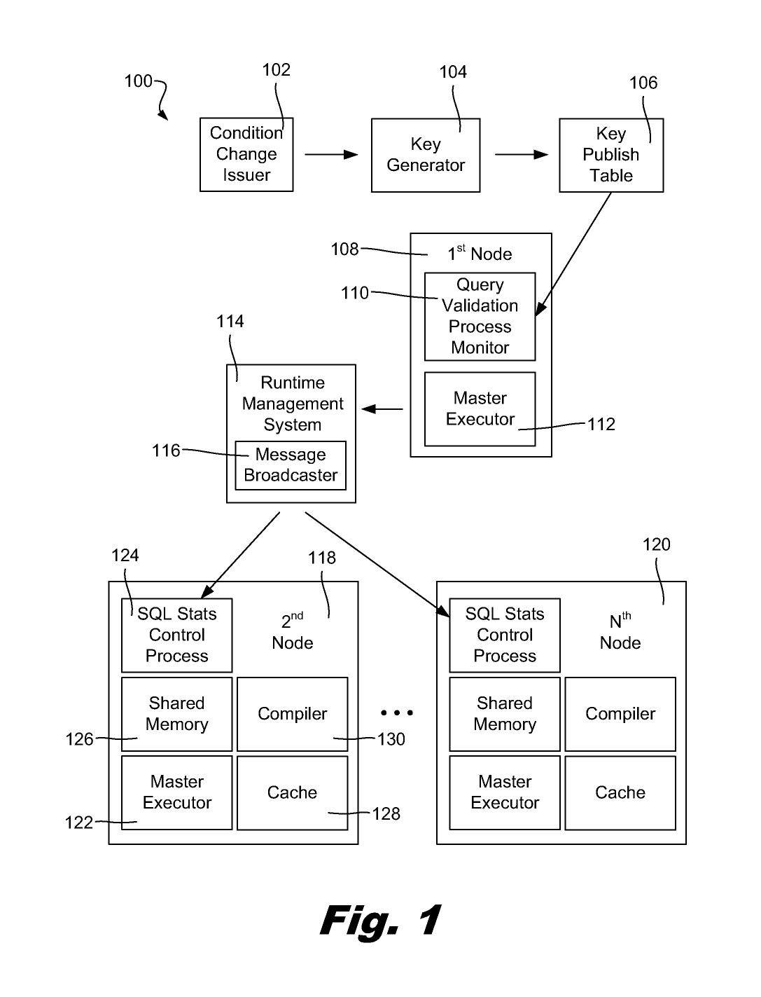

FIG. 1 is a diagram of an example of a validation system (100) according to the principles described herein. In this example, a condition change issuer (102) issues changes to the conditions of a database, and a key generator (104) generates an invalidation key reflecting the change. The key, or a derivative of such a key like a hash value, is recorded in a key publish table (106). A table modifier inserts a row or multiple rows into the key publish table (106) to reflect the change.

The key may include any appropriate type of information. In some examples, the key includes a subject field, an object field, and a type field. The subject field may identify a user or users who are affected by the change. The object field may identify database objects that are affected by the change. The type field may identify the type of change. For example, if the change is the revocation of a first user's privilege to access a table such as Table A in a database, the key may be represented by {first user, Table A, revocation} where first user is inserted into the subject field, Table A is inserted into the object field, and revocation is inserted into the type field. In some examples, the privilege change is to just a portion of a table. In such an example, the revocation of the privilege to access that portion of the table will not affect the user's ability to access the other portions of that table.

When the key includes information that identifies users who are affected by the change, other users outside of the identified users, will not be affected by the change. For example, a second user will not be affected by a key that identifies just the first user. As a consequence, queries that are submitted by the second user will not experience any difference while the first user may be denied access for the same submitted query.

The key publish table (106) may include a row for each changed condition affecting the database. For example, if a privilege granting access to Table A is revoked for the first user, the table modifier may insert a row that identifies this change. If the change affects multiple users or multiple objects, multiple rows may be inserted into the key publish table (106) by the table modifier. For example, if the change includes the revocation for the first and the second user, two new rows may be inserted into the key publish table (106), one for each of the users. In another example, if the first user's privileges to access Table A and Table B are revoked, then two rows may be added to the key publish table (106), one for each of the objects (Table A and Table B), and both indicating the first user as the subject.

A first node (108) may include a query validation monitor process (110) and a master executor (112). The master executor (112) may be in communication with a runtime management system (114) that includes a message broadcaster (116). The query validation process monitor (110) may receive a notification of every successful revoke statement that is issued. In some examples, the notification includes the information in the key, such as the subject, object, type, or other information included in the key. In other examples, the notification includes hash values representing the subject, object, type, or other information included in the key. In yet other examples, the notification includes just a notice of the change, and the query validation process monitor (110) actively retrieves the change from metadata or another location.

The master executor (112) of the first node (108) may send a message to the runtime management system (114) indicating that there has been a change. The runtime management system (114) may cause the message broadcaster (116) or another sending mechanism to send the key or its information to other nodes in a network. These other nodes (118, 120) may include other local master executors (122) that are capable of executing queries with the network's resources. These nodes (118, 120) may be collectively running multiple queries at any given time. For example, these nodes (118, 120) may execute many queries at any given time. While this example has been depicted with just two additional nodes (118, 120) any appropriate number of nodes may be used.

A query language statistics control process (124) of the nodes (118, 120) may receive the broadcasted message from the message broadcaster (116). The statistics control process (124) may write the message to memory (126) that is shared with the local master executors (122). In this manner, the local master executors (122) are made aware of the changes that have been made. The local cache (128) stores the previously executed queries and reuses these queries to save time and resources by avoiding redoing the query plan generation that was performed previously. The local master executors (122) can cause the compiler (130) to recompile the cache or just a portion of the cache to update stored queries with the changes.

As used herein, a compiler (130) is an engine that transforms a textual query into a format suitable for execution by a database system. For example, the key information or the changes written to the shared memory (126) may be rewritten into the query such that the original query is transformed to reflect the current conditions that will affect the execution of the query.

In some examples, the local master executors (122) check the shared memory (126) with the statistics control process (124) to determine whether changes have been made prior to executing a query. If a change has been made, the local master executor (122) can cause at least the portion of the cache that stores the pertinent query to be recompiled before executing the query.

In the example where the first user's privilege to access Table A is revoked from the time lapse between a first submitted query and a second submitted query, the local master executor (122) will deny the first user access to Table A even though the local master executor (122) is reusing the saved query plan that had originally given the first user access to Table A. The saved query can also be updated to reflect other changes, besides just privilege changes. For example, if there is a change in the relationships between tables in a relational database that are included in the query plan for the saved query, the execution plan can be updated to reflect this relationship change.

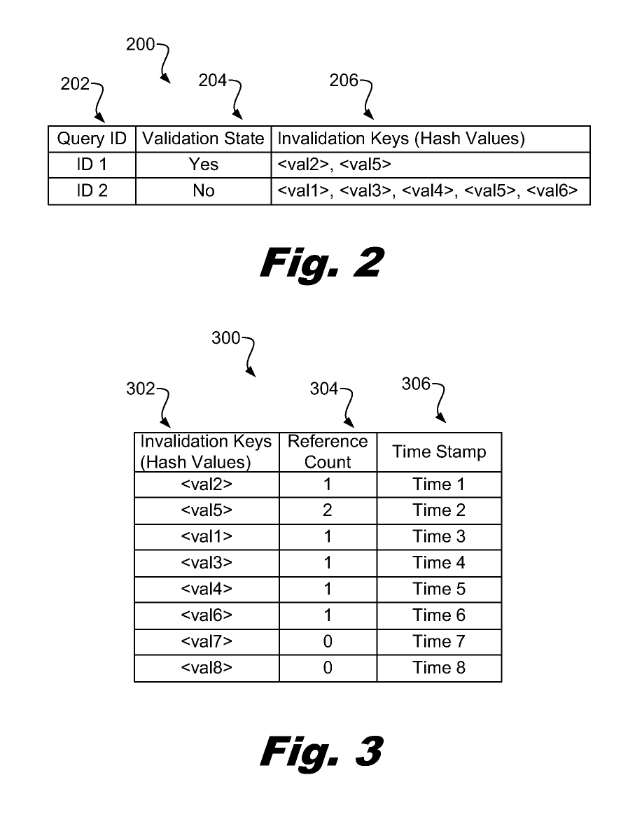

FIG. 2 is a diagram of an example of a query identification table (200), according to the principles described herein. In this example, the query identification table (200) includes a query identification column (202), a validation state column (204), and an invalidation keys column (206). The query identification table (200) may be stored locally with each local master executor.

The local master executors may use the query identification table (200) to determine which of the queries that are stored in the cache are associated with each of the invalidation keys. For example, if a request to perform a query corresponding to the saved query number 2 is received from a first user, the local master executor can look up the invalidation keys associated with query number 2. If query number 2 has an invalidation key that indicates that the first user may no longer have appropriate privileges to access a table referenced in the query, the local master executor can resubmit the query to the compiler. The compiler can determine if the first user still has the appropriate privileges to access to the table, or take some other appropriate action. In some examples, the keys each consume ten bytes of space. However, any appropriate amount of space may be used.

The query identification table can be an existing data structure. The validation state column can have either “yes” or “no” status. Every query identifier starts off with a validation “yes” status. Subsequent revoke statements issued by the condition change issuer can cause the validation state to change to a “no” status. The invalidation keys column (206) includes a list of invalidation keys, each key consuming ten bytes of space.

In some examples, for every data manipulation language (DML) statement it compiles, the SQL compiler produces a list of keys called security invalidation keys. The structure of the security invalidation key may include a hash value of the subject (the user or role holding a privilege), a hash value of the object (the table, view, procedure, user defined function, schema or role for which the privilege is granted), and a type of action (such as a select action, an insert action, a delete action, an update action, or so forth). These three components of the security invalidation key can also be reflected in the structure of any REVOKE statement.

When a query is first executed, the SQL executor adds an entry for the compiled query (query entry) to a query identification table in shared memory. Associated with each query in the query identification table is a list of security invalidation keys that were generated by the SQL compiler. This shared memory also contains a central hash table (central relative to the node) of security invalidation keys with a reference count, as shown in FIG. 3. When the SQL executor adds an entry in the query identification table (200), it increments the reference count for each of the entry's corresponding security invalidation keys in the central hash table. If a particular security invalidation key does not exist in the central hash table, it will be added. When the query ID is removed from the query identification table (200), the reference count for each of the corresponding invalidation keys in the central hash table is decremented.

The shared memory structure can be maintained by a SQL Stats Control Process (SSCP) which is part of the Runtime Management System running on each node. The central hash table within shared memory is shared by all SQL compiler and master executor processes on the node as well as the SSCP process that manages the structure.

At query execution time, the master executor checks the valid flag of its query entries to see if they are still valid. If not, it recompiles the query. If the recompilation was successful, the executor resets the valid flag.

When privileges are revoked, invalidation keys are generated based on the REVOKE statement and are inserted into a special-purpose metadata table called the conditions table.

An administration process called the Query Validation Process (QVP) is run by a cluster of nodes which monitors updates to a condition table via an existing feature called publish/subscribe. After reading an entry from the condition table, the QVP communicates it to its master executor. The master executor then sends a message to a SQL Stats Merge Process (SSMP), which is part of the Run Time Management System on the local node. The SSMP process sends this message onward to every SSCP process of each node in the cluster. When every SSCP process replies stating that the row has been registered in its data structures, QVP deletes the row from the condition table.

FIG. 3 is a diagram of an example of a central hash table (300) according to the principles described herein. In this example, the central hash table (300) includes an invalidation keys column (302), a reference count column (304), and a time stamp column (306).

The central hash table (300) contains a hash value of all active keys. The central hash table (300) may be stored per local master executor or it may be shared among processes in a node. The hash value <value> may include a ten-byte structure consisting of a hash value representing the subject, a hash value representing the object, and an enumerated type representing the action type.

On each node, the SSCP checks the central hash table in shared memory for a matching entry with a reference count greater than zero. For existing entries, it finds the corresponding query entries in the query identification table (200, FIG. 2) and sets their validation state to “no.” The SSCP process also records every row that it receives in its central hash table (300). This is done so that the compiler can get a list of recent revoke statements. Entries in the central hash table (300) with a reference count of zero are removed if they are older than a configured interval of time.

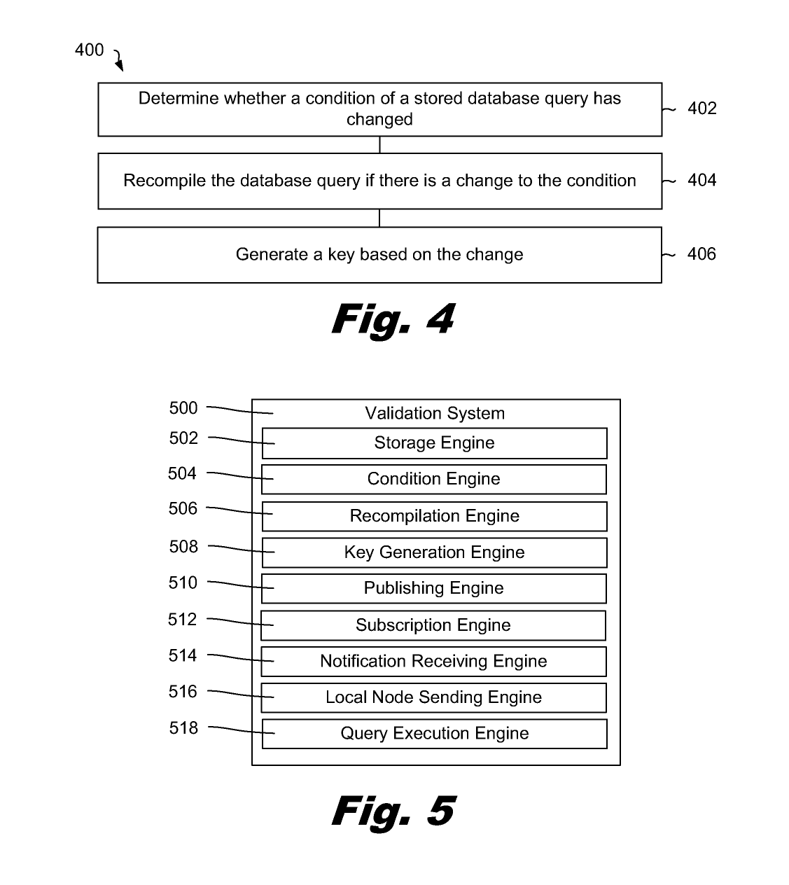

FIG. 4 is a diagram of an example of a method (400) for validating a query execution according to the principles described herein. In this example, the method (400) includes determining (402) whether a condition of a stored database query has changed, recompiling (404) the database query if there has been a change to the condition, and generating (406) a key based on the change. In some examples, the condition is a revocation of a privilege, type of access, another type of condition, or combinations thereof.

The principles described herein allow a relational database management system (RDBMS) to enforce complex privilege rules during query compilation. It also ensures that the privilege information stays current as the compiled plans await execution or are stored in a compiler cache. An advantage of this approach is that query performance is not affected and may even be slightly improved when compared to other solutions. The time taken for a change in privilege to be visible across the system is sub-seconds for many system loads and hence there is reduced likelihood of queries being allowed to execute with stale privilege information. Another advantage of this approach is that users or their queries that are not affected by a given privilege change (those users who are not identified in the key) will not be affected. Also, currently executing queries will not be terminated or suspended even if a privilege change is made on an object that is used by the query. The approach is scalable and places no limits on the number of nodes that are available on the system or the number of database objects. Increasing the number of nodes or number or database objects does not significantly increase the amount of time taken for a privilege change to be visible across all nodes. This method can be extended to accommodate propagating changes in database object definitions that will cause a stored plan to be no longer viable.

Privilege information can be visualized as a more or less three dimensional space, a matrix with users and roles in one dimension (rows) and with SQL objects like tables, views, their columns and privilege types in another dimension (columns), while the access type (such as SELECT or INSERT) form the third dimension. Grant and revoke statements can affect zero or more elements of this matrix. The dimensions themselves have some structure, with users and roles being related, and tables and views being related. Changes in this matrix can cause previously validated queries that may either be awaiting execution in the execution engine or may be stored in a compiler cache to become invalid. The principles described herein provide a fast invalidation method, which indicates if a previously validated query should be revalidated for security. This approach solves the issue of enforcing complex privilege inheritance rules without affecting the execution performance of the queries. Enforcement of privileges is done during compile time along with other metadata accesses. Any changes in privilege information between compile time and execution time is communicated across the system to all interested processes by transmitting a concise security key that encodes the change in the privileges. The runtime performance of queries is not affected by this validation. No query or user is falsely penalized for a privilege change that does not apply to it.

RDBMS users can obtain the privilege to access a database object either directly or from membership in predefined roles. The roles themselves could form a complex hierarchy. A given query may require different types of access to multiple database objects. Often, the SQL compiler determines if a user has sufficient privileges to execute a given SQL query by reading the privilege information stored in the metadata. At least two types of issues could potentially result in a user being able to access an object after their privileges have been revoked. In such examples, the privileges can change after the last time the SQL compiler gathered information about a particular object for particular user. The first issue is that some of the user's privileges could change between compile time and runtime. The second issue is that the compiler caches could contain stale privilege information. The principles described herein include a mechanism for the SQL execution engines and SQL compilers in a system to validate that the privilege information is current prior to the query execution or prior to a compiler cache lookup. This mechanism uses inter-process messaging to push recent privilege activity on the system to all nodes, as well as shared memory in each node and to have this information readily accessible by any SQL compiler or execution engine on that node. In some examples, changes in privilege information are communicated across all nodes of the system with sub-second response times. There may be no impact on currently executing queries and there may be negligible impact on the performance of queries due to this privilege validation prior to execution. Queries are not penalized for a change in privilege that do not apply to it.

The issues of stale compiler caches and compiled plans having stale privilege information can be resolved by rapid communication of revoke information to all currently executing compiler and master executor processes in that system. Such communication can be achieved by using a shared memory segment in every node of the system that is shared by all master executor processes executing on that node. The shared memory segment is part of the runtime management system employed on the system.

Also, registering the query identification in every master executor process for every DML statement received at prepare time in shared memory segment assists with communicating with the nodes in an efficient manner. Along with the query identification, a list of the security invalidation keys is recorded in a compact form (a ten byte hashed representation). The validation state of the query is also marked as “valid.” In other words, each DML statement causes one row to be added to a table in the shared segment by the master executor.

The query identification state may be set to “invalid” in the shared memory segment in an appropriate manner. When a revoke statement is issued anywhere on the system, all the shared memory segments on the system receive a notification. When the shared memory segments receive the notification, it checks to see if it has any matching query in its list. If so, the query identification state will be marked invalid.

The master executor, prior to execution, checks the state of the query identification associated with the query in the shared memory segment. If the query identification state is invalid, the query is recompiled to obtain the updated privileges.

The principles described herein also include having the compiler, prior to the actual compilation, retrieve all recent security invalidation keys from the shared memory segment of the local node. This information is used to de-cache all affected objects from the compiler cache as well as to de-cache all queries from any other cache if they have lost their privileges to execute.

In a failure scenario, all processes that make up the Run Time Management system and the QVP process are configured to be persistent. They will be brought back up with the contents of the shared segment preserved as before. If the QVP process goes down and the node is still up, then the QVP process will be restarted by the operating system. If the node that contains QVP goes down, the QVP can be started on an alternate node.

The compiler caches and prepared statements held by master executors in that local node will be lost after a node failure. In such a situation, if the QVP process was lost, it can be restarted. If the process fails while it was updating the shared memory, any query entries owned by that process are discarded and their reference count from the hash table are adjusted.

The following table includes examples of invalidation keys (subject, object, type) for a DML statement with the associated conditions:

| Condition | Example Invalidation Key |
|---|---|
| User u has direct privilege of type y on | (u, t, y) |
| base table t | |
| User u has privilege of type y on a view v | (u, v, y) |
| User u has role r, r has privilege of type y | (u, r, role), (r, o, y) |
| on table-like object o | |
| User u has role r₂, which has role r₁, | (u, r₂, role), (r₂, r₁, role), |
| which has privilege y on o | (r₁, o, y) |
| User u has roles r₁ . . . rₙ, and more than | (x, o, y) where ‘x’ is any |
| one element of the set {u, r₁, . . . rₙ} has | member from the set {u, |
| the privilege y on o | r₁, . . . , rₙ} with privilege y |
| Revoke privilege y on table-like object o | (u, o, y) |
| from user u | |
| Revoke privilege y on table-like object o | (r, o, y) |
| from role r | |
| Revoke role r from user u | (u, r, role) |
| Revoke role r₁ from role r₂ | (r₂, r₁, role) |

The advantage of this model is that no messages or disk input/outputs are used to check privileges at execution time. The check can be done on every execution of the query. Further, the system does not have to invalidate any of queries that are really unaffected by a REVOKE statement (e.g. all queries referencing table T1.) Also, the burden can move from the query to the REVOKE statement to ensure all affected queries are notified. The REVOKE operations are transactional and take effect near instantaneously. It is also possible to produce a list of all active queries that are affected by a REVOKE statement and, in some instances, to delete those queries.

This model works for all objects, supports hierarchical roles, and is scalable in a distributed environment. Further, this model could be extended to other DDL operations that can be used whenever some latency is tolerated between the DDL statement being committed and statement actually taking effect.

FIG. 5 is a diagram of an example of a validation system (500) according to the principles described herein. In this example, the following engines may be present in the validation system (500): a storage engine (502), a condition engine (504), a recompilation engine (506), a key generation engine (508), a publishing engine (510), a subscription engine (512), a notification receiving engine (514), local node sending engine (516), and a query execution engine (518). The engines (502, 504, 506, 508, 510, 512, 514, 516, 518) refer to a combination of hardware and program instructions to perform a designated function. Each of the engines (502, 504, 506, 508, 510, 512, 514, 516, 518) may include processors and memory. The program instructions are stored in the memory and cause the processor to execute the designated function of the engine.

The storage engine (502) stores the query in a local cache of a node. The conditions engine (504) determines a change in a condition affecting a query. The conditions engine (504) may determine whether there is a change that affects a query with a key publish table that is generated by a publishing engine (510). A key generation engine (508) may generate a key in response to a changed condition and cause a row to be added to the publishing indicating the change and, in some instances, related details.

A subscription engine (512) of a node may subscribe to receive notifications for the changes to the query publish table. The node may have a notification receiving engine (514) to receive the notifications about the changes. The local node sending engine (516) may broadcast or otherwise send the notification to local nodes. The recompilation engine (506) recompiles a locally stored query if there is a change in a condition that affects that query. The query execution engine (518) causes a query to be executed based on a query plan stored in the local cache.

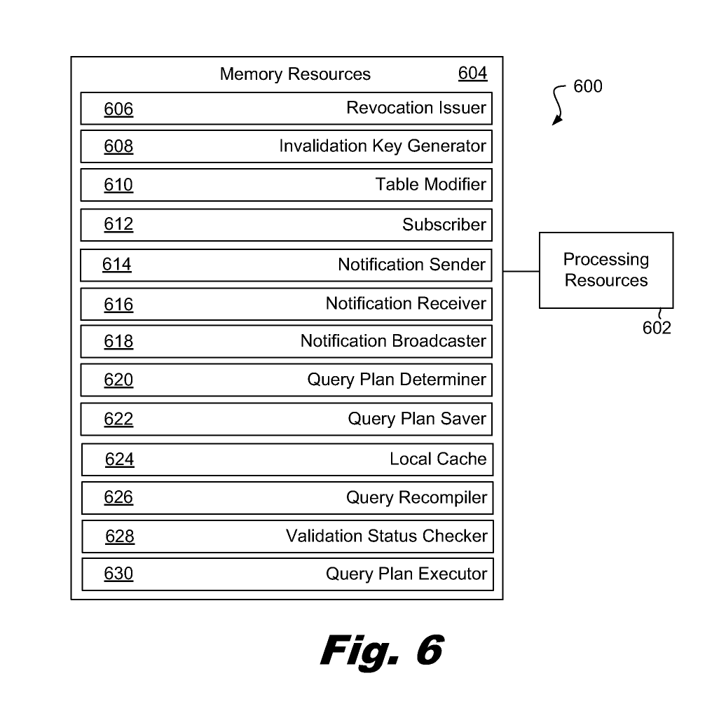

FIG. 6 is a diagram of an example of a validation system (600) according to the principles described herein. In this example, the validation system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the validation system (600). The programmed instructions shown stored in the memory resources (604) include a revocation issuer (606), an invalidation key generator (608), a table modifier (610), a subscriber (612), a notification sender (614), a notification receiver (616), a notification broadcaster (618), a query plan determiner (620), a query plan saver (622), a query recompiler (626), a validation status checker (628), and a query plan executor (630). The data structures shown stored in the memory resources (604) include a local cache (624).

The memory resources (604) include a computer readable storage medium that contains computer readable program code to cause tasks to be executed by the processing resources (602). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, magnetic storage media, other types of memory, or combinations thereof.

The revocation issuer (606) represents programmed instructions that, when executed, cause the processing resources (602) to issue a revoke statement in response to a change in a user's privileges. The invalidation key generator (608) represents programmed instructions that, when executed, cause the processing resources (602) to generate an invalidation key based on the change. The table modifier (610) represents programmed instructions that, when executed, cause the processing resources (602) to modify a key publish table with the invalidation key.

The subscriber (612) represents programmed instructions that, when executed, cause the processing resources (602) to subscribe to a service that provides notifications about the changes made to the key publish table. The notification sender (614) represents programmed instructions that, when executed, cause the processing resources (602) to sends the notifications about the changes to the key publish table. The notification receiver (616) represents programmed instructions that, when executed, cause the processing resources (602) to receive the sent notifications. The notification broadcaster (618) represents programmed instructions that, when executed, cause the processing resources (602) to broadcast the notification to the local nodes.

The query plan determiner (620) represents programmed instructions that, when executed, cause the processing resources (602) to determine a query plan based on a submitted query input. The query plan saver (622) represents programmed instructions that, when executed, cause the processing resources (602) to save the query plan developed by the query plan determiner (620) in a local cache (624) of the local node.

The query recompiler (626) represents programmed instructions that, when executed, cause the processing resources (602) to recompile a query plan if a condition change affects the query plan. For example, the query recompiler (626) may recompile the query if there is a privilege change, an index change, a relationship change, another type of change that does not behoove the generation of an entirely new query plan. The validation status checker (628) represents programmed instructions that, when executed, cause the processing resources (602) to check the status of changes prior to the execution of the query. The query plan executor (630) represents programmed instructions that, when executed, cause the processing resources (602) to execute the query plan.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (604) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries may be accessed from a remote location over a network connection while the programmed instructions are located locally. Thus, the validation system (600) may be implemented on a user device, on a server, on a collection of servers, or combinations thereof.

The validation system (600) of FIG. 6 may be part of a general purpose computer. However, in alternative examples, the validation system (600) is part of an application specific integrated circuit.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for validating a database query execution, comprising:
determining whether a condition of a stored database query has changed;
recompiling said database query if there is a change to said condition; and
generating a key based on said change.

2. The method of claim 1, wherein said condition is a revocation of a privilege, type of access, or combinations thereof.

3. The method of claim 1, wherein said condition is an alteration of a database table.

4. The method of claim 1, wherein said condition is a relationship of a database table.

5. The method of claim 1, wherein said key includes a subject field, an object field, and a type field.

6. The method of claim 1, further comprising sending said key to local nodes that execute queries.

7. The method of claim 1, wherein determining whether said condition of said database query has changed includes subscribing with a subscription to a key publish table engine.

8. The method of claim 7, further comprising receiving a notification from said key publish table engine based on said subscription when said condition has changed.

9. The method of claim 1, further comprising storing said database query in memory storage.

10. A system for validating a database query execution, comprising of:
a storing engine to store a database query in memory storage;
a condition engine to determine whether a condition of said database query has changed; and
a recompiling engine to recompile said database query if there is a change to said condition.

11. The system of claim 10, further comprising a key generation engine to generate a key based on said change.

12. The system of claim 10, further comprising a key publish table engine to track changes to said condition.

13. The system of claim 12, further comprising a subscription engine to subscribe to a key publish table engine.

14. The system of claim 10, further comprising a database query execution engine to execute said database query.

15. A computer program product for validating a database query execution, comprising:
a non-transitory computer readable storage medium that comprises program instructions that, when executed, causes a processor to:
store a database query in memory storage;
determine whether there is a change to a condition of said database query;
generate a key based on said change;
send said key to a database query execution engine; and
recompile said database query if said condition has changed.
